(19) United States
(12) Patent Application Publication
(10) Pub. No.: US 2025/0272115 A1
(43) Pub. Date: Aug. 28, 2025

(54) DYNAMIC PERSONALIZED BANKING USER INTERFACE

(71) Applicant: Wells Fargo Bank, N.A, San Francisco, CA (US)

(72) Inventors: Ananya Bandyopadhyay, Ranchi (IN); Vivek Kalyanaraman, Bengaluru (IN); Suranjana Sarkar, Bangalore (IN); Vinothkumar Venkataraman, Bengaluru (IN)

(21) Appl. No.: 17/936,488

(22) Filed: Sep. 29, 2022

(51) Int. Cl. G06F 9/451; G06F 3/0482; G06F 3/0484; G06N 20/00; G06Q 40/02

(52) U.S. Cl. CPC G06F 9/451; G06F 3/0482; G06F 3/0484; G06N 20/00; G06Q 40/02

(57) ABSTRACT

Systems and methods may generally provide a dynamic personalized banking user interface. An example method may include receiving data corresponding to a user pathway interaction by a user at a user interface, and personalizing, using reinforcement learning, a trained model to the user based on the data to generate a personalized reinforcement learning model. The example method may include receiving an indication that the user has accessed the user interface or requested access to the user interface, and dynamically generating the user interface using the personalized reinforcement learning model. The dynamically generated user interface may be output for display on a user device.

### BACKGROUND

User interfaces are used to display information on websites, mobile apps, and other applications. Interacting with banks can be cumbersome and daunting for users. As users navigate their lives, their interactions and banking needs often change based on various factors. In some cases, users feel frustrated when their needs are not immediately fulfilled, and often users are unable to accurately communicate those banking needs themselves.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example user interface showing a user pathway interaction in accordance with some embodiments.

FIG. 2 illustrates a dynamic change to a user interface in accordance with some embodiments.

FIGS. 3A-3D illustrate dynamically generated user interfaces in accordance with some embodiments.

FIG. 4 illustrates machine learning engine for training and execution related to dynamic user interface generation or changes in accordance with some embodiments.

FIG. 5 illustrates a flowchart showing a technique for providing a dynamic personalized banking user interface in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide a technological framework to provide a personalized user interface to a user based on previous interactions by the user with a website, app, or the like. The personalized user interface may present one or more unique views, components, menus, etc. to a user based user interactions. The personalized user interface may improve access, search, or time spent for a user on the interface.

The systems and techniques described herein solve the technological problem of accessibility and customization for traditionally one-size-fits-all user interfaces, such as banking apps, websites, etc. The technological problem is a structural one that involves search constraints, difficulty in layouts based on display screen limitations, app or website framework limitations, or the like. The solutions provided herein improve user (e.g., customer) experience by reducing the time a user must take to access a component of an app or website, making a component easier to find (e.g., overcoming a display device limitation), customizing an experience for a user, or the like. The systems and techniques described herein increase efficiency by reducing a number of clicks a user must make to access a frequently accessed component or information. The systems and techniques described herein reduce the effort and time required for a user to obtain basic information, for example, by providing frequently accessed information when a user hovers a mouse over a particular area of a user interface. The systems and techniques described herein may provide a customized browsing experience based on user activity patterns, needs and existing details.

An example issue with current apps and websites is that users have to perform many actions (e.g., clicks, taps, mouse movements, keystrokes, zoom, long press, eye tracking, etc.) to navigate to a part of a user interface that the user wants to access. This may result in lost time for the user because the page is not customized based on the user's needs in logging on to the system.

A large amount of data is generated from mouse hovers/movements, taps, keystrokes, etc., used by a user during an interaction with a user interface. This information may be leveraged (e.g., with a user request or approval) to customize the user interface for the user. For example, when a user wants to check a banking app to determine whether the user has been paid, that user may need to log in, go in through a tab or menu to view balances, etc. in a traditional banking app. The user may then need to check how much is due on a bill, return to a checking account to check transactions, etc. This results in a lot of mouse movement data. The pattern of mouse movement, taps, or keystrokes may be used optionally with metadata such as a date, timestamp, or frequency of use to estimate or predict a browsing pattern of the user. The browsing pattern may be used to make the user interface more interactive and create a custom user interface.

In some examples, a hover feature (e.g., when a mouse rests over a particular component of a user interface), a right click, a long press on a touchscreen, a keypress, a combination of these gestures, or the like may be used to display information, which may be selectable. The information displayed may include basic information, intelligent insight, a key performance indicator (KPI), a recommended product or service or the like, for example of the feature on which the mouse is hovering.

The systems and techniques described herein may score long term activity to identify a sequence or series of mouse, tap, or keyboard actions to predict a next action a user will perform. These systems and techniques may be used to create a user interface that is dynamic, customized, visually appealing, user friendly, or the like. Reinforcement learning may be used to update the user interface based on further user interactions. Training of a model or reinforcement learning may include using a cost function that emphasizes minimizing user interactions. In some examples, the user interface design may be changed based on user feedback.

A time-based analysis may be performed using the systems and techniques described herein. For example, a time-based reminder or change to a user interface may be provided. In some examples, an annual, monthly, weekly, etc. change may occur for a user interface. For example, the user interface may make accessing tax information easier by placing a user interface component on a home screen in February or March. In another example, at a beginning of month or end of month, checking or savings information may be made more prominent. In yet another example, on a payday of a user, a first user interface may display paycheck information. A user interface may be customized for a user by replacing a user interface

component, moving a user interface component, rearranging a menu (e.g., moving a dropdown menu item up or down), moving a tab left or right, or the like. In some examples, a custom user interface may be generated as a user interacts with a website or app. In some examples, a custom user interface may be generated at a next access attempt by a user (e.g., a next login, a next visit to a website or app, after selection of a link or user interface component, etc.). A user interface may be customized by changing a color, a template, a layout, a design, or the like. A user interface may be customized by bringing a component to a foreground or a background (e.g., when two or more components overlap.

The systems and techniques described herein may provide a customized user interface that is designed uniquely for a particular user. In some examples, a base model (e.g., a machine learning model) may be generated. In response to receiving at least one user interaction with a user interface, the base model may be modified to be custom to the user (e.g., using reinforcement learning, using the user interactions as a side input to the base model, by retraining the base model, by weighting an input to the base model, etc.). In some examples the base model may be modified and in others it may be regenerated. User interactions over time may be captured to further modify the user interface or improve the model. A model may include a Q-Learning model, a Deep Q Network model, a Monte Carlo technique, for example, using policy evaluation and policy improvement, a State-Action-Reward-State-Action (SARSA) technique, a Deep Deterministic Policy Gradient (DDPG) technique, or the like.

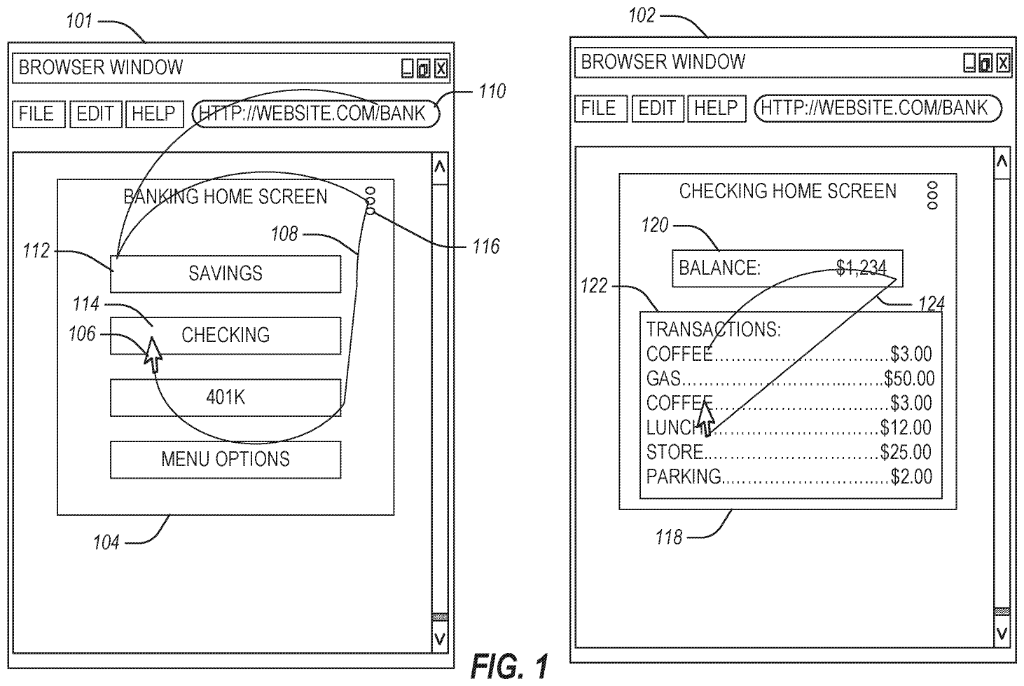

FIG. 1 illustrates example user interfaces 101 and 102 showing user pathway interactions in accordance with some embodiments. User interface 101 illustrates a first user pathway 108 representing a path taken by a user input indicator 106 as it is moved around the user interface 101. For example, the user input indicator 106 may start at a URL entry component 110, move to a savings account component 112, move to and hover over a settings component 116, and then move to finish at a checking account component 114 on a banking home screen 104. The first user pathway 108 may represents an initial or early use of the banking home screen 104 for a particular user (e.g., without any or with only a few saved pathways). The first user pathway 108 may be saved or stored. The first user pathway 108 may be used alone or with additional user pathways (e.g., of the user, of another user or multiple other users, etc.) to change the user interface 101. In some examples, the user interface 101 may be changed based on the first user pathway 108 in the session on the banking home screen 104 where the first user pathway 108 occurred. In other examples, the user interface 101 may be changed for subsequent visits to the banking home screen 104 (e.g., a next visit, a next logged in visit, etc.). While banking user interface is discussed as an example herein, the subject matter described may apply to a user interface for other purposes, such as a merchant website, a gaming app, an online encyclopedia, etc.

The user interface 102 shows a second user pathway 124 through a checking home screen 118 (e.g., after the user selected the checking account component 114 on the banking home screen 104 in user interface 101). The second user pathway 124 may start with the cursor in a location corresponding to the checking account component 114 of user interface 101 (e.g., user interface 102 may be the resulting view when the checking account component 114 is selected in the user interface 101). The second user pathway 124 includes movement over a balance component 120, and then back to a transactions component 122. The second user pathway 124 may be saved.

The first or second user pathways may be parsed to determine details of the user interactions, such as products or services used, transaction patterns or other data records (e.g., hover). These interaction details may be used to modify or generate a custom user interface for the user. For example, a pattern of mouse movements may be recorded and the repetitive patterns may be identified along with their frequency and timings. This information may be used with a reinforcement learning algorithm, in some examples, to predict future activity of the user. In some examples, future activity may be predicted based on frequency of actions in user pathways. For example, this information may be used by the reinforcement algorithm in combination with existing information of different products or services being used by the user to create long term activity scoring. Based on the long-term activity scoring, a recommendation engine may generate insights to provide a suggestion for financial planning based on savings or spending patterns or goals in some examples.

In some examples, frequently accessed information may be used with analytical information to generate a recommendation to be presented to the user, for example, as a tooltip. The tooltip may lead to a customized interface on a single click to allow the user to directly access some information in a personalized way. For example, when a pathway includes a user accessing a particular dashboard and spending greater than a threshold amount of time looking for a same section (e.g., bill pay on bill due date; checking balance on pay day, etc.), the section may be made more accessible (e.g., by moving it up to a top position in a drop down menu, making it visually distinct via color or highlight, making it a top component, etc.).

The first user pathway 108 or the second user pathway 124 may include a mouse hover, which may be detected based on capturing a pixel when the mouse is not moved (e.g., for a threshold period of time, such as a second). The first user pathway 108 or the second user pathway 124 may be used to generate a heatmap of where the user is moving the mouse or clicking on the user interface 101 or 102. The first user pathway 108 or the second user pathway 124 may be used to determine a pattern of user interaction preference (e.g., user goes to checking then to savings then back to checking).

A model (e.g., a machine learning model) may be used to generate a personalized user interface based on user interactions including the first user pathway 108 or the second user pathway 124, for example. The model may include a reinforcement learning model. The reinforcement learning model may use a user pattern identified (e.g., from the first user pathway 108 or the second user pathway 124) to predict a next interaction by the user. The reinforcement learning model may use an input to be customized to a user. The input may include, for a time interval at which an interaction is occurring, identifying information the user is trying to retrieve, (e.g., identifying a hover), recording a mouse movement or keystroke pattern, and identifying a link, entity, component, product, or service the user is attempting to interact with. In some examples, text pattern matching and pixel locations may be used. The reinforcement learning model may use a reward in training, such as minimizing clicks (e.g., fewer clicks is a higher reward).

In some examples, an output from the reinforcement learning model may be used to identify and analyze existing products or services to recommend a new product or service to a user based on an identified user interaction pattern. For example, information identified by the reinforcement learning model may be is fed into a recommendation engine to output a recommendation. The recommendation engine may use existing user information to create an insight or suggestion.

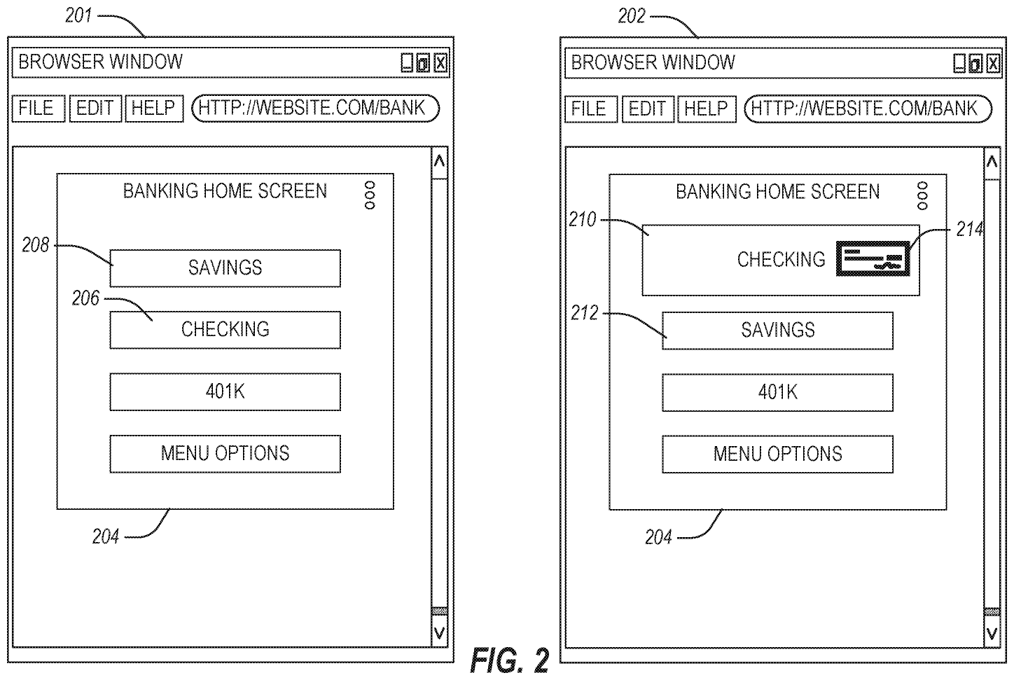

FIG. 2 illustrates a dynamic change to a user interface in accordance with some embodiments. A first instance 201 of the user interface illustrates several components of a banking home screen 204, such as a checking component 206 and a savings component 208. The checking component 206 is shown below the savings component 208 (e.g., in a default view of the banking home screen 204), and having a same size. In response to a user interaction (e.g., a pathway, a pattern, etc.), for example based on a model, the user interface may be modified to a second instance 202. The second instance 202 may be displayed at a subsequent visit to the user interface by a user, or may be modified in real-time.

The second instance 202 shows a new arrangement of user interface components, including a second checking component 210 and a second savings component 212. The second checking component 210 is now larger and above the second savings component 212. This change may be in response to a user clicking on the checking component 206, having a pathway that indicates the user attempts to click on the checking component 206 (e.g., a click near but not on the checking component 206), etc.

The second checking component 210 includes an optional additional change, including an icon 214 displayed on the second checking component 210. The icon 214 may be used to create a visual distinction for the second checking component 210 compared to other components of the banking home screen 204. In some examples, the icon 214 may be separately selectable, for example to take a user to a particular checking screen (e.g., cash a check), or may display information when interacts with the icon 214 in some way (e.g., when a user hovers over the icon 214). The displayed information may include a checking account balance, for example.

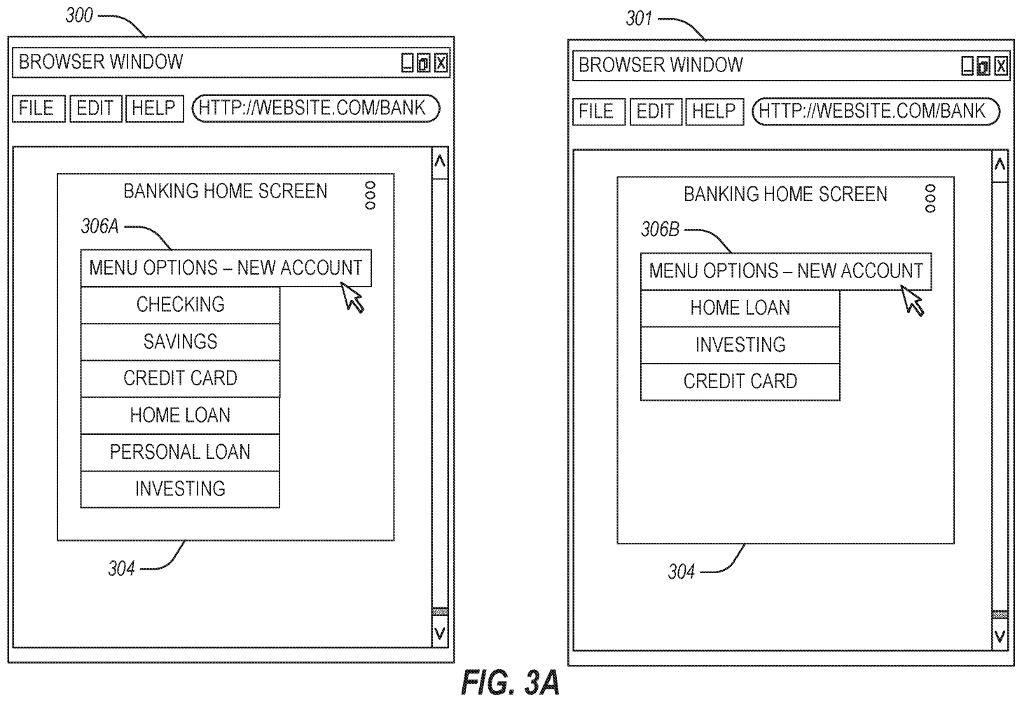

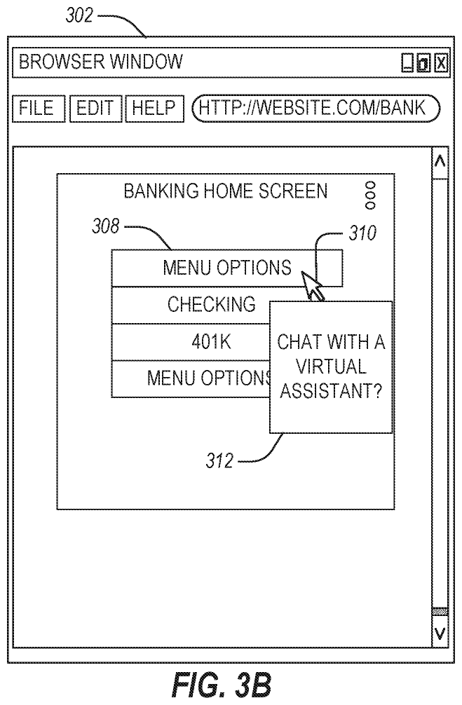

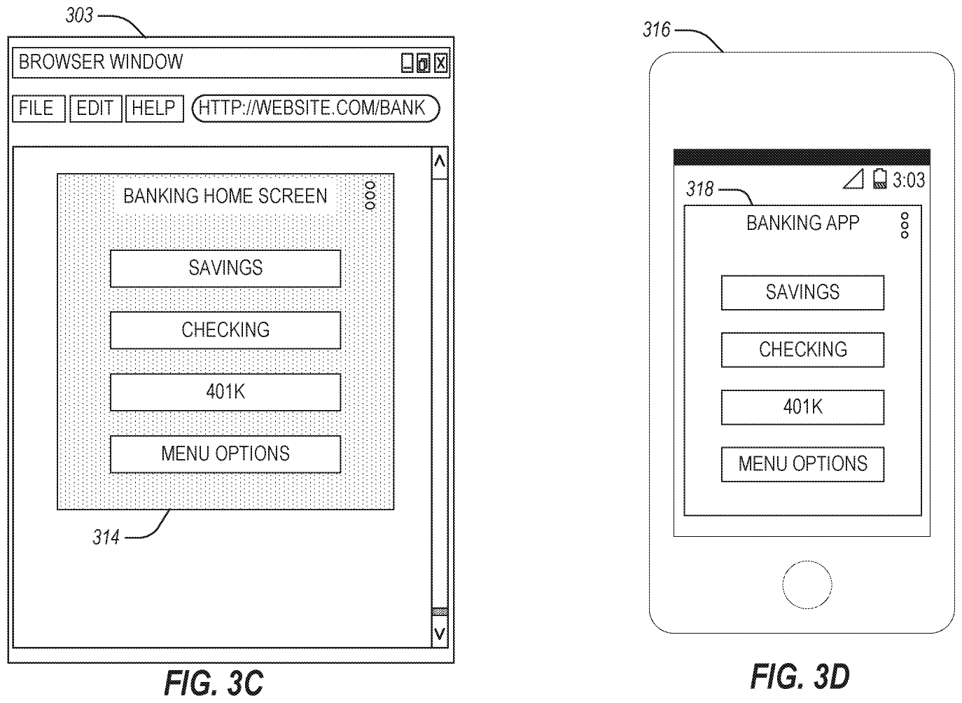

FIGS. 3A-3D illustrate dynamically generated user interfaces in accordance with some embodiments. The user interfaces of FIGS. 3A-3D are representative examples, meant to show various techniques that may be used to modify a user interface. These user interfaces are not exhaustive or intended to be limiting. The user interfaces of FIGS. 3A-3D may be generated in response to a user interaction with a user interface as described herein (e.g., using a model, a user pathway, a pattern of interaction, etc.).

FIG. 3A illustrates a custom menu, for example, with changes to menu options from instance 300 to instance 301 of the user interface. A banking home screen 304 in instance 300 illustrates a menu 306A with several options, including checking, savings, credit card, home loan, personal loan, investing, etc. Instance 301 shows the banking home screen 304 with a modified menu 306B having options for home loan, investing, and credit card. The menu changes from menu 306A to 306B may be made in response to determining that a user rarely or never accesses the other options in this particular menu. The options for checking, savings, and credit card may be found elsewhere in the banking app or website. In some examples, the changes from menu 306A to 306B may be made in response to determining that the user frequently interacts with the home loan, investing, and credit card options of this menu.

FIG. 3B illustrates an overlay 312 displayed on instance 302 of a user interface. The overlay 312 may be displayed in response to determining the mouse 310 is hovering over the menu options component 308, for example. The overlay 312 may include a suggestion to chat, for example, with a virtual assistant. The overlay 312 may be displayed based on a prior user interaction, such as a user entering and exiting menu 308 repeatedly (e.g., indicating the user is looking for something that the user cannot find). The overlay 312 may be displayed when the mouse 310 hovers over the menu component 308 and may be removed when the mouse 310 moves or is no longer located over the menu component 308. In an example, the overlay 312 may remain visible while the mouse 310 is over the menu component 308, even if the mouse 310 moves. In some examples, the overlay 312 may remain if the mouse 310 moves generally in the direction of the overlay 312, over the overlay 312, or interacts with the overlay 312.

FIG. 3C illustrates a user interface instance 303 that includes a change to a background style or color of a banking home screen 314. The background of the banking home screen 314 may be modified in response to a user interaction. For example, when a user repeatedly misses clicking on a component, a background style or color may be changed to provide additional visual contrast to make it easier for the user to see where a mouse and components are located to facilitate selecting a component. In other examples, the background may be changed based on a user interaction indicating the user appreciates design changes (e.g., frequent selection of visual settings changes), or to improve user interaction metrics (e.g., when the background changes, a user may be more inclined to visit more frequently).

FIG. 3D illustrates a mobile banking app 318 displayed on a mobile device 316. The custom user interfaces, changes to components of user interfaces, user interactions, and the like as described herein may be applied to a user interface of the mobile device 316. In some examples, user interactions may differ (e.g., tap instead of mouse click), but similar or same models and techniques may be used. In some examples, a custom model for mobile devices may be used (which may also be customized for a user of the particular mobile device 316 using reinforcement learning, for example, as described herein). User interactions at a mobile device may be different than at a browser window. For example, users may prefer to check account balances on a mobile device, but may prefer to make changes to a 401 k or check a mortgage using a larger screen with a browser (e.g., a computer, a tablet, etc.). In other examples, a wearable device may be used to access aspects of a banking app or website. The techniques and systems described herein may be used to customize a user interface or components displayed on the wearable device. In some examples, cross device input may be used for a model (e.g., mobile device input may be used to generate or modify a model for a wearable device).

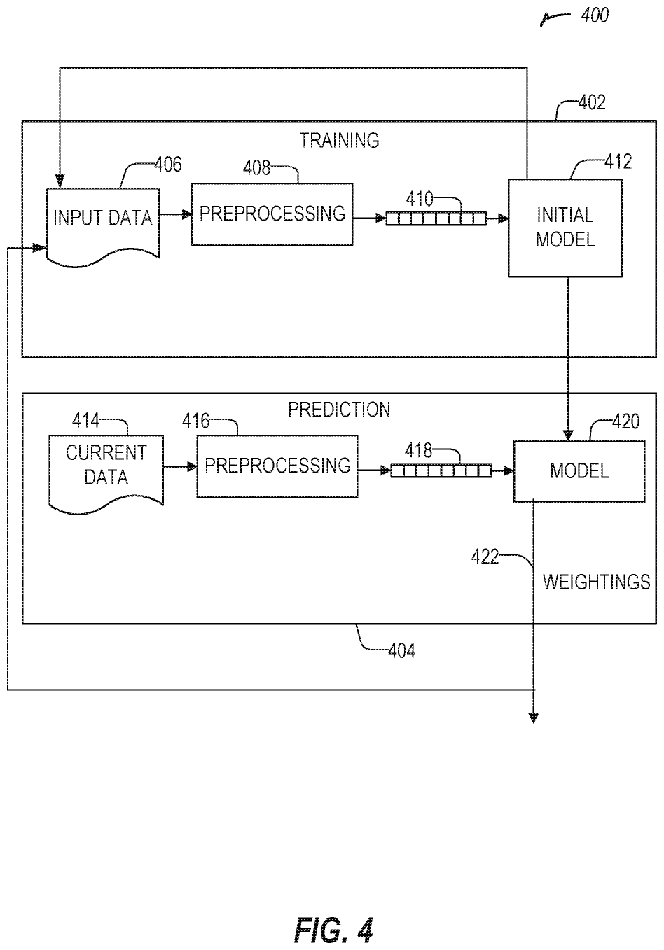

FIG. 4 illustrates machine learning engine for training and execution related to dynamic user interface generation or changes in accordance with some embodiments. The machine learning engine may be deployed to execute at a mobile device (e.g., a cell phone) or a computer. A system may calculate one or more weightings for criteria based upon one or more machine learning algorithms. FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning).

The input data 406 may include previous recorded data of user interaction with a user interface, such as a user pathway through a website (e.g., a time-series of data). The input data 406 in this example may include user interactions at a user interface such as a website. The user interactions may include a mouse movement, a mouse click (e.g., left click or right click), a mouse hover, a scroll interaction, a touch on a touchscreen (e.g., short or long touch), a dragging operation (e.g., via touch or mouse movement), a keystroke, or the like. In some examples, multiple models may be generated, such as for each user (e.g., personalized to the user).

In the prediction engine 404, current data 414 (e.g., a user accessing a user interface such as a website, for example by logging in, opening a URL or app on a phone, or the like) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In other examples, the training engine 402 may operate in an online manner (e.g., at a mobile device). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user. Labels for the input data 406 may include an ultimate destination of a user (e.g., an endpoint of a user pathway), a selected component on a user interface, a user specified intent (e.g., via a feedback component), a time to a destination, or the like. The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output a predicted component or user interface configuration for a particular user, a group of users, or the like. In some examples, the model 420 may output a general model, which may be used to generate a personalized model via reinforcement learning when a particular user's data is used to further refine the general model.

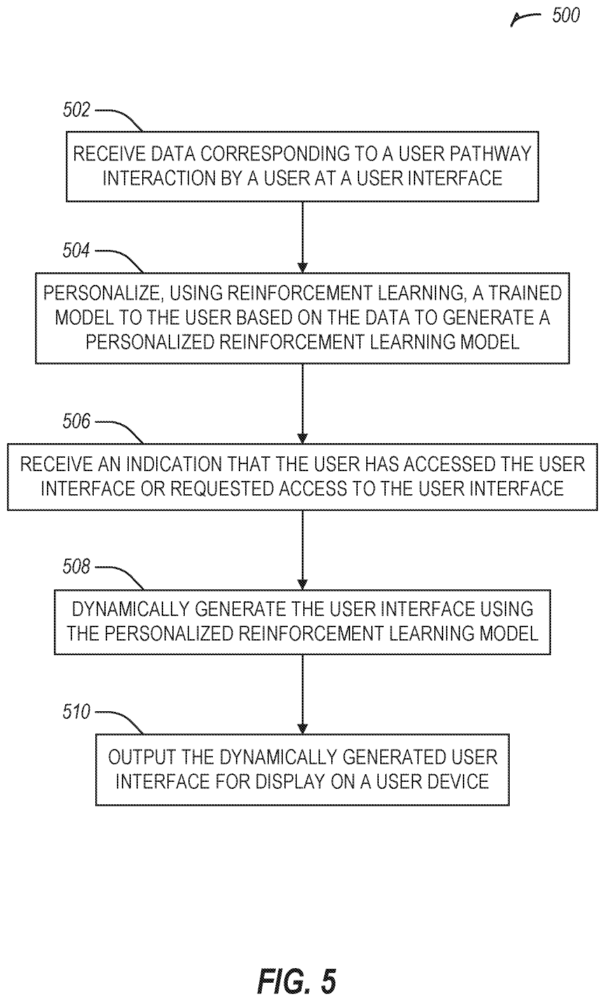

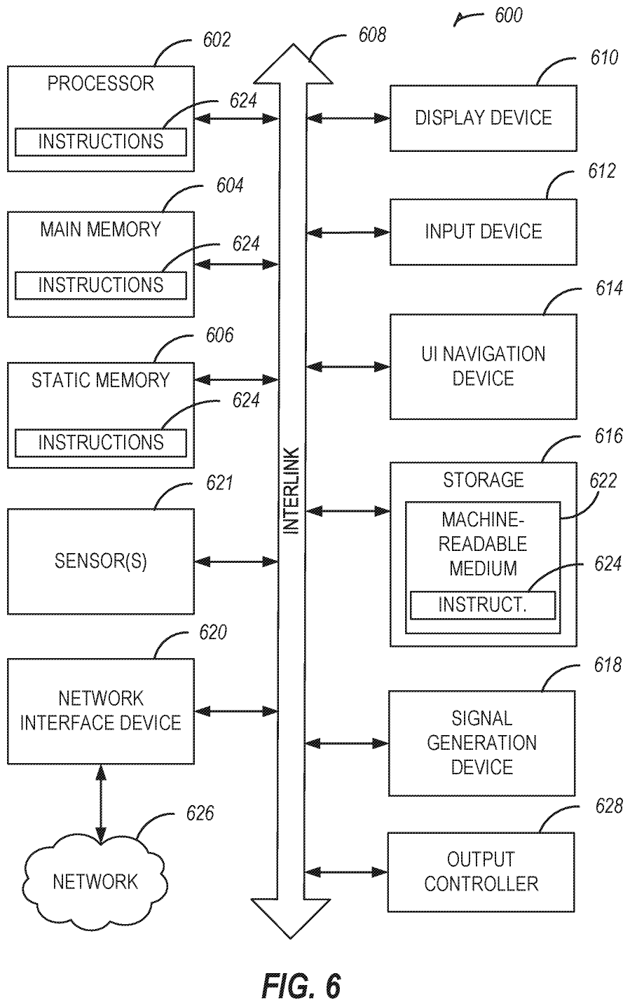

FIG. 5 illustrates a flowchart showing a technique 500 for providing a dynamic personalized banking user interface in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to receive data corresponding to a user pathway interaction by a user at a user interface. In some examples, the data corresponding to the user pathway interaction may include at least one of a mouse movement, a keystroke, a mouse click, a tap on a touchscreen, or the like. The data corresponding to the user pathway interaction may include a location of a pixel when a mouse controlled by the user is stationary. The data corresponding to the user pathway interaction may include a heatmap of the user pathway interaction.

The technique 500 includes an operation 504 to personalize, using reinforcement learning, a trained model to the user based on the data to generate a personalized reinforcement learning model. The trained model may be trained to output a prediction of a user interface component to be accessed next by a general user. For example, the trained model may be a general model that is later personalized to the user (e.g., using the reinforcement learning model). Operation 504 may include using at least one of Q-Learning, a deep Q network, a Monte Carlo technique including policy evaluation and policy improvement, a State-Action-Reward-State-Action (SARSA), a Deep Deterministic Policy Gradient (DDPG), or the like.

The technique 500 includes an operation 506 to receive an indication that the user has accessed the user interface or requested access to the user interface. For example, when a user logs in, goes to a URL, opens a document (e.g., an email), clicks a link, or the like, the user may be accessing or requesting access to the user interface.

The technique 500 includes an operation 508 to dynamically generate the user interface using the personalized reinforcement learning model. Operation 508 may include using at least one of replacing a user interface component, moving a user interface component, adding a user interface component, rearranging a menu, or the like. In some examples, operation 508 includes determining a current time of year and generating the user interface based on the current time of year (e.g., a user may access tax information more often in March and April, a 401 k account at an end of the year after a bonus, etc.). Operation 508 may include determining a current day of a current month and generating the user interface based on the current day of the current month (e.g., a user may look at a direct deposit account on paydays, a savings account at an end of a month, etc.). In some examples, operation 508 includes changing at least one of a color, a template, a layout, a design element of the user interface, or the like.

The technique 500 includes an operation 510 to output the dynamically generated user interface for display on a user device. The technique 500 may include receiving an indication of a mouse hover over a user interface component of the dynamically generated user interface, and in response, displaying a menu to access an item selected using the personalized reinforcement learning model. The technique 500 may include receiving additional data corresponding to a second user pathway interaction at the dynamically generated user interface, and changing the dynamically generated user interface using the personalized reinforcement learning model including at least one of replacing a user interface component, moving a user interface component, adding a user interface component, or rearranging a menu.

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving data corresponding to a user pathway interaction by a user at a user interface; personalizing, using reinforcement learning, a trained model to the user based on the data to generate a personalized reinforcement learning model; receiving an indication that the user has accessed the user interface or requested access to the user interface; dynamically generating the user interface using the personalized reinforcement learning model including at least one of replacing a user interface component, moving a user interface component, adding a user interface component, or rearranging a menu; and outputting the dynamically generated user interface for display on a user device.

In Example 2, the subject matter of Example 1 includes, wherein the data corresponding to the user pathway interaction includes at least one of a mouse movement, a keystroke, a mouse click, or a tap on a touchscreen.

In Example 3, the subject matter of Examples 1-2 includes, receiving an indication of a mouse hover over a user interface component of the dynamically generated user interface, and in response, displaying a menu to access an item selected using the personalized reinforcement learning model.

In Example 4, the subject matter of Examples 1-3 includes, wherein dynamically generating the user interface includes determining a current time of year and generating the user interface based on the current time of year.

In Example 5, the subject matter of Examples 1-4 includes, wherein dynamically generating the user interface includes determining a current day of a current month and generating the user interface based on the current day of the current month.

In Example 6, the subject matter of Examples 1-5 includes, wherein the trained model is trained to output a prediction of a user interface component to be accessed next by a general user.

In Example 7, the subject matter of Examples 1-6 includes, receiving additional data corresponding to a second user pathway interaction at the dynamically generated user interface, and changing the dynamically generated user interface using the personalized reinforcement learning model including at least one of replacing a user interface component, moving a user interface component, adding a user interface component, or rearranging a menu.

In Example 8, the subject matter of Examples 1-7 includes, wherein dynamically generating the user interface using the personalized reinforcement learning model includes changing at least one of a color, a template, a layout, or a design element of the user interface.

In Example 9, the subject matter of Examples 1-8 includes, wherein the data corresponding to the user pathway interaction includes a location of a pixel when a mouse controlled by the user is stationary.

In Example 10, the subject matter of Examples 1-9 includes, wherein the data corresponding to the user pathway interaction includes a heatmap of the user pathway interaction.

In Example 11, the subject matter of Examples 1-10 includes, wherein personalizing the trained model using reinforcement learning includes using at least one of Q-Learning, a deep Q network, a Monte Carlo technique including policy evaluation and policy improvement, a State-Action-Reward-State-Action (SARSA), or a Deep Deterministic Policy Gradient (DDPG).

Example 12 is at least one non-transitory machine-readable medium including instructions, which when executed by processing circuitry, cause the processing circuitry to perform operations to: receive data corresponding to a user pathway interaction by a user at a user interface; personalize, using reinforcement learning, a trained model to the user based on the data to generate a personalized reinforcement learning model; receive an indication that the user has accessed the user interface or requested access to the user interface; dynamically generate the user interface using the personalized reinforcement learning model including at least one of replacing a user interface component, moving a user interface component, adding a user interface component, or rearranging a menu; and output the dynamically generated user interface for display on a user device.

In Example 13, the subject matter of Example 12 includes, wherein the data corresponding to the user pathway interaction includes at least one of a mouse movement, a keystroke, a mouse click, or a tap on a touchscreen.

In Example 14, the subject matter of Examples 12-13 includes, wherein the operations further cause the processing circuitry to receive an indication of a mouse hover over a user interface component of the dynamically generated user interface, and in response, display a menu to access an item selected using the personalized reinforcement learning model.

In Example 15, the subject matter of Examples 12-14 includes, wherein to dynamically generate the user interface, the operations further cause the processing circuitry to determine a current time of year and generating the user interface based on the current time of year.

In Example 16, the subject matter of Examples 12-15 includes, wherein to dynamically generate the user interface, the operations further cause the processing circuitry to determine a current day of a current month and generating the user interface based on the current day of the current month.

In Example 17, the subject matter of Examples 12-16 includes, wherein the trained model is trained to output a prediction of a user interface component to be accessed next by a general user.

In Example 18, the subject matter of Examples 12-17 includes, wherein to personalize the trained model using reinforcement learning the operations further cause the processing circuitry to use at least one of Q-Learning, a deep Q network, a Monte Carlo technique including policy evaluation and policy improvement, a State-Action-Reward-State-Action (SARSA), or a Deep Deterministic Policy Gradient (DDPG).

Example 19 is a system comprising: processing circuitry; and memory, including instructions, which when executed by the processing circuitry, cause the processing circuitry to perform operations to: receive data corresponding to a user pathway interaction by a user at a user interface; personalize, using reinforcement learning, a trained model to the user based on the data to generate a personalized reinforcement learning model; receive an indication that the user has accessed the user interface or requested access to the user interface; dynamically generate the user interface using the personalized reinforcement learning model including at least one of replacing a user interface component, moving a user interface component, adding a user interface component, or rearranging a menu; and output the dynamically generated user interface for display on a user device.

In Example 20, the subject matter of Example 19 includes, wherein to personalize the trained model using reinforcement learning the operations further cause the processing circuitry to use at least one of Q-Learning, a deep Q network, a Monte Carlo technique including policy evaluation and policy improvement, a State-Action-Reward-State-Action (SARSA), or a Deep Deterministic Policy Gradient (DDPG).

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
receiving data corresponding to a user pathway interaction by a user at a first instance of a user interface;
personalizing, using reinforcement learning with a cost function based on minimizing user interactions, a trained base model to the user based on the data to generate a personalized reinforcement learning model;
subsequent to the personalizing, receiving an indication that the user has requested access to the user interface;
dynamically generating a second instance of the user interface using the personalized reinforcement learning model including at least one of replacing a user interface component, moving a user interface component, adding a user interface component, or rearranging a menu; and
outputting the dynamically generated second instance of the user interface for display on a user device.

2. The method of claim 1, wherein the data corresponding to the user pathway interaction includes at least one of a mouse movement, a keystroke, a mouse click, or a tap on a touchscreen.

3. The method of claim 1, further comprising receiving an indication of a mouse hover over a user interface component of the dynamically generated user interface, and in response, displaying a menu to access an item selected using the personalized reinforcement learning model.

4. The method of claim 1, wherein dynamically generating the user interface includes determining a current time of year and generating the user interface based on the current time of year.

5. The method of claim 1, wherein dynamically generating the user interface includes determining a current day of a current month and generating the user interface based on the current day of the current month.

6. The method of claim 1, wherein the trained base model is trained to output a prediction of a user interface component to be accessed next by a general user.

7. The method of claim 1, further comprising receiving additional data corresponding to a second user pathway interaction at the dynamically generated user interface, and changing the dynamically generated user interface using the personalized reinforcement learning model including at least one of replacing a user interface component, moving a user interface component, adding a user interface component, or rearranging a menu.

8. The method of claim 1, wherein dynamically generating the user interface using the personalized reinforcement learning model includes changing at least one of a color, a template, a layout, or a design element of the user interface.

9. The method of claim 1, wherein the data corresponding to the user pathway interaction includes a location of a pixel when a mouse controlled by the user is stationary.

10. The method of claim 1, wherein the data corresponding to the user pathway interaction includes a heatmap of the user pathway interaction.

11. The method of claim 1, wherein personalizing the trained base model using reinforcement learning includes using at least one of Q-Learning, a deep Q network, a Monte Carlo technique including policy evaluation and policy improvement, a State-Action-Reward-State-Action (SARSA), or a Deep Deterministic Policy Gradient (DDPG).

12. At least one non-transitory machine-readable medium including instructions, which when executed by processing circuitry, cause the processing circuitry to perform operations to:
receive data corresponding to a user pathway interaction by a user at a first instance of a user interface;
personalize, using reinforcement learning with a cost function based on minimizing user interactions, a trained base model to the user based on the data to generate a personalized reinforcement learning model;
subsequent to the personalizing, receive an indication that the user has requested access to the user interface;
dynamically generate a second instance of the user interface using the personalized reinforcement learning model including at least one of replacing a user interface component, moving a user interface component, adding a user interface component, or rearranging a menu; and
output the dynamically generated second instance of the user interface for display on a user device.

13. The at least one machine-readable medium of claim 12, wherein the data corresponding to the user pathway interaction includes at least one of a mouse movement, a keystroke, a mouse click, or a tap on a touchscreen.

14. The at least one machine-readable medium of claim 12, wherein the operations further cause the processing circuitry to receive an indication of a mouse hover over a user interface component of the dynamically generated user interface, and in response, display a menu to access an item selected using the personalized reinforcement learning model.

15. The at least one machine-readable medium of claim 12, wherein to dynamically generate the user interface, the operations further cause the processing circuitry to determine a current time of year and generating the user interface based on the current time of year.

16. The at least one machine-readable medium of claim 12, wherein to dynamically generate the user interface, the operations further cause the processing circuitry to determine a current day of a current month and generating the user interface based on the current day of the current month.

17. The at least one machine-readable medium of claim 12, wherein the trained base model is trained to output a prediction of a user interface component to be accessed next by a general user.

18. The at least one machine-readable medium of claim 12, wherein to personalize the trained based model using reinforcement learning the operations further cause the processing circuitry to use at least one of Q-Learning, a deep Q network, a Monte Carlo technique including policy evaluation and policy improvement, a State-Action-Reward-State-Action (SARSA), or a Deep Deterministic Policy Gradient (DDPG).

19. A system comprising:
processing circuitry; and
memory, including instructions, which when executed by the processing circuitry, cause the processing circuitry to perform operations to:
receive data corresponding to a user pathway interaction by a user at a first instance of a user interface;
personalize, using reinforcement learning with a cost function based on minimizing user interactions, a trained base model to the user based on the data to generate a personalized reinforcement learning model;
subsequent to the personalizing, receive an indication that the user has requested access to the user interface;
dynamically generate a second instance of the user interface using the personalized reinforcement learning model including at least one of replacing a user interface component, moving a user interface component, adding a user interface component, or rearranging a menu; and
output the dynamically generated second instance of the user interface for display on a user device.

20. The system of claim 19, wherein to personalize the trained base model using reinforcement learning the operations further cause the processing circuitry to use at least one of Q-Learning, a deep Q network, a Monte Carlo technique including policy evaluation and policy improvement, a State-Action-Reward-State-Action (SARSA), or a Deep Deterministic Policy Gradient (DDPG).
